(19) United States
(12) Patent Application Publication
(10) Pub. No.: US 2016/0205172 A1
(43) Pub. Date: Jul. 14, 2016

(54) OFFLOADING GRAPH BASED COMPUTATIONS TO A BACKEND DEVICE

(71) Applicant: Futurewei Technologies, Inc., Plano, TX (US)

(72) Inventors: Vineet Chadha, Milpitas, CA (US); Guangyu Shi, Cupertino, CA (US); Gopinath Palani, Sunnyvale, CA (US)

(21) Appl. No.: 14/592,664

(22) Filed: Jan. 8, 2015

(51) Int. Cl. H04L 29/08; H04L 29/06

(52) U.S. Cl. CPC H04L 67/10; H04L 67/42

(57) ABSTRACT

An apparatus is configured to perform a method for a graph based computation. The method includes receiving a procedural call from an application server, the procedural call comprising at least one primitive extended from a distributed file system (DFS) protocol. The method also includes initiating at least one virtual machine. The method further includes performing a graph based computation based on the procedural call using the at least one virtual machine. The method still further includes transmitting a result of the graph based computation to the application server.

### TECHNICAL FIELD

The present disclosure relates generally to graph-based systems, and more particularly, to a system and method for offloading graph-based computations to a backend device.

### BACKGROUND

In computer science, graphs are mathematical structures that are used to model pairwise relationships between objects. In this context, graphs are comprised of vertices (also called “nodes”) and that are connected by lines (also called “edges”). Graph-based computation models are becoming increasingly common in Big Data environments, such as social networks or internet search engines. Big Data refers to collections of data sets that are so large and complex that processing of the data becomes difficult using traditional data processing methods and applications. Emerging computation models involving Big Data are often focused on computation near the node where data is resident. While new models of computation have emerged or become more prominent, the protocol for sharing and computing data is often the same as in existing data sharing protocols, such as NFS (network file system).

### SUMMARY

According to one embodiment, there is provided a method for a graph based computation. The method includes receiving a procedural call from an application server, the procedural call comprising at least one primitive extended from a distributed file system (DFS) protocol. The method also includes initiating at least one virtual machine. The method further includes performing a graph based computation based on the procedural call using the at least one virtual machine. The method still further includes transmitting a result of the graph based computation to the application server.

According to another embodiment, there is provided an apparatus for a graph based computation. The apparatus includes at least one memory and at least one processor coupled to the at least one memory. The at least one processor is configured to receive a procedural call from an application server, the procedural call comprising at least one primitive extended from a DFS protocol; initiate at least one virtual machine; perform a graph based computation based on the procedural call using the at least one virtual machine; and transmit a result of the graph based computation to the application server.

According to yet another embodiment, there is provided a non-transitory computer readable medium embodying a computer program. The computer program includes computer readable program code for receiving a procedural call from an application server, the procedural call comprising at least one primitive extended from a DFS protocol; initiating at least one virtual machine; performing a graph based computation based on the procedural call using the at least one virtual machine; and transmitting a result of the graph based computation to the application server.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example system for offloading graph-based computations to a backend device, according to this disclosure;

FIG. 2 illustrates an example sequence of events that occur during the offloading of graph-based operations and the deployment of process level virtual machines, according to this disclosure; and

FIG. 3 illustrates an example graph computation using multiple graphing primitives in the system of FIG. 1, according to this disclosure.

### DETAILED DESCRIPTION

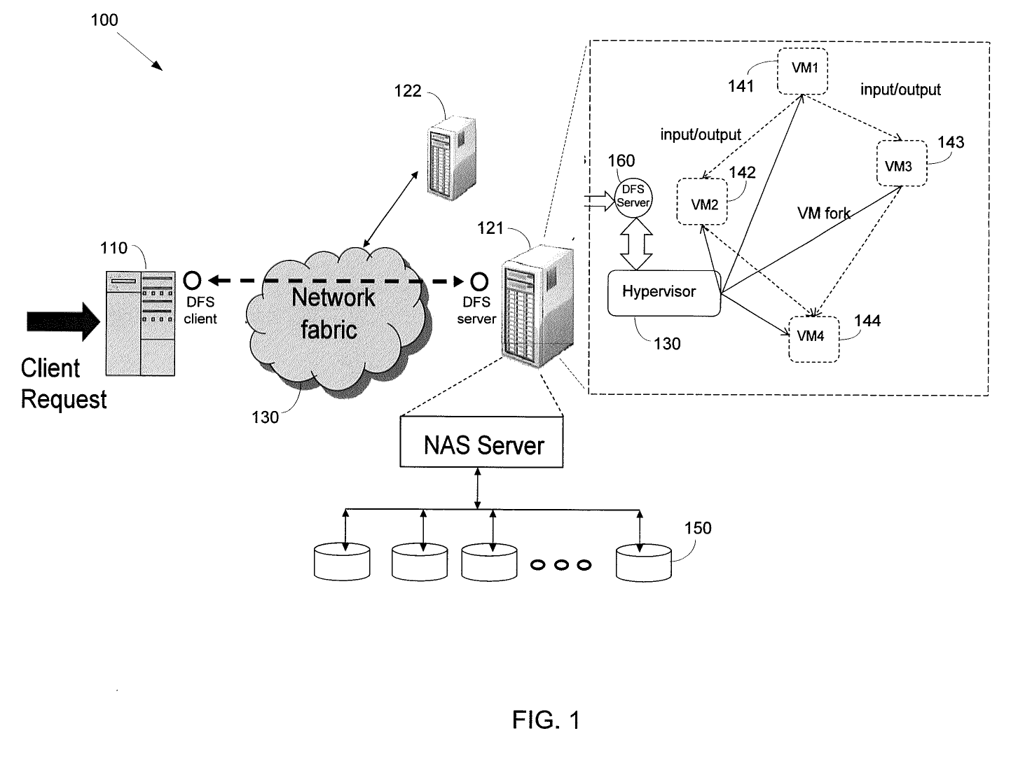

FIGS. 1 through 3, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Graph based computation is a commonly used methodology to correlate events, information, and people in data analytics. In graph based computation models, the data analytics computation is typically iterative and recursive. Computation is event driven, i.e., the output of one node drives one or more other nodes. Currently, industry lacks a solution to offload and execute iterative or graph based computation on a distributed file storage server, such as a NFS (network file system) or CIFS (common Internet file system) server.

One example of graph based data processing is GOOGLE's MapReduce system. Another example is GOOGLE's Pregel system, which facilitates the processing of the connected localized data and global synchronization of the data (i.e., the nodes exchange data among each other) through a communication protocol (e.g., the BSP (bulk synchronous parallel) protocol). While MapReduce models provide a generic framework for computation, Pregel provides an optimized, large scale model to compute highly connected graphs. In Pregel, very large graphs are partitioned so as to maximize the localization of data computation. Compared to graph databases (which provide a rich functionality set over the domain of OLAP (online analytical processing) and OLTP (online transaction processing)), Pregel is designed for large amounts of data for analytics (with a focus on graph based approaches).

Graph based models of computation are common. One example of graph based computation is the graph based search engine utilized in many social network systems. In such systems, the data center nodes are distributed. Big Data processing techniques are often used through various models of processing, such as batch processing, in-stream processing, or query processing. Data associated in these models are distributed in nature and often different compute models are associated with the data (e.g., MapReduce, BSP, and the like).

Distributed storage architectures have been previously defined with common storage primitives such as ‘read’, ‘write’, ‘lock’, etc. While these operations have been used to access or store the data, the processing capabilities of the storage-side NAS (network attached storage) devices are usually less tapped by the application server. These NAS devices are configured to perform functions such as snapshot, clones, thin provisioning, replication, de-duplications, and automated tiering (e.g., use of server level disk array controllers). To take advantage of these resources, embodiments of this disclosure provide extended APIs based on graph operations to tap the storage-side resources for application processing at the backend device.

The embodiments disclosed herein provide a novel mechanism to offload graph based computations commonly used in typical Big Data applications to the storage node. The disclosed embodiments are based on extensions to standard protocols, thus they have the potential for standardization. The disclosed embodiments extend the current distributed protocols for data handing so as to steer the computation towards the storage node with emphasis on graph based computation. Using this approach, a graph description is encoded and sent closer to the storage, where it is executed in the controlled environment of lightweight virtual machines (VMs). This approach supports new graph based computation at a distributed level. Placing the operations at the storage end reduces data fetching latency and frees resources at the application server to be utilized for other purposes.

The disclosed embodiments of graph based computation utilize lightweight VMs at the storage end. This is possible through the extended distributed protocol by embedding data operations (or semantics) with pointers to data on the storage device.

Some embodiments of the graph based approach include the following features, which are described in greater detail below:
Scheduling computation (which may be iterative or recursive on the same node);
Template VMs to perform specialized tasks (i.e., a node) and pre-configured VMs to exchange the message or results at the backend device. Each VM acts as a graph node and each message exchange between the VMs acts as an edge. The graph configuration is facilitated by a hypervisor or indirection layer that keeps track of VM execution;
Each VM includes a specialized stack to perform the secured computation.

In the context of this disclosure, a distributed protocol can be used. The protocol can be based on an existing file system or can be a new protocol to leverage backend resources. In some embodiments, the protocol sends a configuration file to the backend device based on the needs of the application, and bootstraps strings of VMs.

FIG. 1 illustrates an example system for offloading graph-based computations to a backend device, according to this disclosure. The system 100 includes an application server 110 in communication with a plurality of NAS devices 121-122 via a network 130. While two NAS devices 121-122 are shown in FIG. 1, it will be understood that the system 100 may include more or fewer NAS devices.

The application server 110 represents a computing or communication device configured to offload graph-based computations to a backend device, such as the NAS devices 121-122. The application server 110 may be any suitable computing device that is capable of receiving information from another device, processing information, and transmitting information to another device. For example, the application server 110 may be a desktop computer, a laptop computer, a server, or any other suitable computing device. The application server 110 may include one or more application programming interfaces (APIs), network communications applications, or any other software, firmware, hardware (such as one or more processors, controllers, storage devices, and circuitry), or combination thereof that is capable of offloading graph-based computations to a backend device.

The application server 110 is configured to perform one or more functions of a distributed file system (DFS) client. In particular embodiments, the application server 110 acts as a network file system (NFS) or common internet file system (CIFS) client.

Each NAS device 121-122 represents a computing or communication device configured to receive information from a device (such as the application server 110) and perform graph-based computations. Each NAS device 121-122 may be any suitable computing device that is capable of receiving information from another device, processing information, and transmitting information to another device. For example, each NAS device 121-122 may be a desktop computer, a laptop computer, a server, or any other suitable computing device. Depending on embodiments, each NAS device may include lower-end processors (such as those with an ARM core) or higher-end processors (such as INTEL XEON processors). As particular examples, each NAS device 121-122 (sometimes referred to as a “NAS filer”) could be configured with 64-bit 6-core, INTEL XEON 2.93 GHz processors with 192 GB of memory.

The NAS devices 121-122 are configured to perform one or more functions of a DFS server. In particular embodiments, each NAS device 121-122 acts as a NFS or CIFS server.

Communication between the application server 110 and the NAS devices 121-122 is made possible via the network 130. The network 130 may be implemented by any medium or mechanism that provides for the exchange of data between various computing devices. Examples of such networks include a Local Area Network (LAN), a Wide Area Network (WAN), an Ethernet network, the Internet, or one or more terrestrial, satellite, or wireless links. The network 130 may include a combination of two or more networks, such as two or more of those described above. The network 130 may transmit data according to the Transmission Control Protocol (TCP), User Datagram Protocol (UDP), Internet Protocol (IP), or any other suitable networking protocol(s).

Each NAS device 121-122 includes a hypervisor 130 and a plurality of VMs 141-144. For the sake of clarity, in FIG. 1, only the NAS device 121 is shown with these components. However, it will be understood that each NAS device 121-122 can be configured with the same or similar components as the other NAS device, and each can be configured to perform the same or similar operations as the other. The NAS device 121 performs the functions of a NAS server, and includes or is coupled to one or more data storages 150. The data storage 150 includes at least one memory. The data storage 150 stores instructions and data used, generated, or collected by the NAS device 121. For example, the data storage 150 could store software or firmware instructions executed by processor(s) of the NAS device 121, and data associated with one or more graph based computations. The data storage 150 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

The hypervisor 130 (also referred to as a virtual machine monitor (VMM)) represents one or more of computer software, firmware or hardware that is configured to create, run, or manage one or more virtual machines. In particular embodiments, the hypervisor 130 is (or includes) a ZeroVM cloud hypervisor, as described in greater detail below. In the system 100, the hypervisor 130 performs the functions of a virtual machine monitor for the VMs 141-144.

Each VM 141-144 is a compute node of a lightweight virtual machine that is forked at run time, or is a reused existing VM. The VMs 141-144 can be configured as process level VMs that can provide a specialized stack for application execution. In general, a process level virtual machine can be used to provide either a sandboxed environment for a group of processes to execute securely or to provide platform independence to one or more user applications. Process level VMs have become more prominent with the advent of virtualized containers such as OpenVZ and LINUX container (LXC). One operating system for providing a specialized stack is Exokernel. Exokernel is a type of library operating system (libOS) that reduces the abstraction typically offered by monolithic operating systems. Using Exokernel, some or all of the functionality of the operating system is exported to the user level. In some systems, an application is linked dynamically with one or more specialized operating system runtime environments and one or more specialized device drivers to remove the overhead incurred in traditional operating systems.

Typically, libOS environments provide one or more interfaces, such as process management, paging, file system, and system call interfaces. With the advent of Big Data, it has become helpful to move processing of the data closer to the storage. In some environments, this concept is extrapolated to a case of converged storage, which is characterized by the processing controller and the storage controller on the same dies or very close to each other. Such environments can reduce or eliminate bus latency or network latency by offloading tasks to the storage.

An example of lightweight virtualization based on libOS principals is ZeroVM. ZeroVM offers isolation of single processes or tasks into separate containers. Thus, an environment using ZeroVM allows the sandboxing of essential tasks only (as opposed to sandboxing the complete software stack). The approach taken by ZeroVM is based on GOOGLE Native Client, a sandbox environment used by GOOGLE's CHROME web browser. Features of ZeroVM include restricted memory access for applications, the ability to run foreign compiled source code, and system call restrictions. In ZeroVM, abstraction is very limited so as to expose a very small surface of external interference. Application execution inside the storage can be applied with a template manifest so as to change the behavior of storage containers based on configuration parameters. Typically, various abstraction layers are added on top of the storage appliance in order to provide customized services for the client request. Examples include LINUX LUN (Logical Unit Number) or volume, which are used to provide the abstraction of capacity. Similarly, there are storage appliances that are specialized for virtualization.

In some systems, it is possible to utilize multiple categories for the template containers for the deployment of process level VMs on the storage side, e.g., capacity, throughput, virtualization, and functional transformation. While such a move towards specialized and minimal-stack-based VMs offers some advantages, these systems suffer from flexibility and productivity at a large scale, and still have multiple layers of indirections in overhead.

To address these issues, the system 100 employs lightweight virtualization based on ZeroVM, which is based on GOOGLE Native Client. GOOGLE Native Client has been well tested, is configured to run foreign applications (e.g., graphics, audio) in the browser, and provides a secure execution environment for applications. Additionally, the ZeroVM-based hypervisor 130 uses a smaller memory footprint to execute the VMs 141-144.

In the context of implementation, the ZeroVM virtualization can include Google Native client, a Zero Message queue for messaging, and MessagePack. For communication, ZeroVM includes multiple channels (e.g., random read and seq write). The VMs 141-144 are forked through a configuration file that stores one or more representative parameters to bootstrap a secured environment. These parameters are dynamically configured by a user level application module when a modified remote procedural call (RPC) is invoked with embedded semantics.

In one aspect of operation, a client request is transmitted to the application server 110. The client request is encoded with computation information and input/output information. In the context of a graph based model, the computation information is associated with one or more nodes and the input/output information is associated with one or more graph edges. The client request is sent to the NAS device 121, where a modified distributed file system (DFS) server 160 requests the hypervisor 130 to bootstrap the VMs 141-144 to schedule the VMs at the backend NAS device 121.

In particular embodiments, the application server 110 and the NAS devices 121-122 are configured to operate according to the NFS protocol. The NFS protocol is a network protocol based on remote procedural calls (RPCs). The NFS protocol divides a remote file into blocks of equal size and supports on-demand, block-based transfer of file contents. Multiple procedural calls are defined for the NFS protocol, including ‘read’, ‘lookup’, ‘readdir’, ‘remove’, etc. To further explain a procedural call in NFS, a simple example application invoking a read call through a ‘cat’ utility is considered. In the context of the NFS protocol, ‘file’ or ‘dir’ objects are addressed through an opaque file handle. Any read call is preceded by a lookup to locate the file object to be read. Then the read call is invoked iteratively a number of times, depending on the NFS configuration and file size to be fetched.

With the increase in Big Data and file sizes as new types of workloads emerge into industry, operations such as a read operation over a distributed file system could be very expensive. For large scale data, the system 100 embeds the operations, logic, or semantics behind the fetching of data from the backend device into the traditional distributed protocol. In the system 100, the NAS device 121 can seamlessly execute a ‘Join’ operation and give results back to the application server 110 in the server address space, thus saving the cost of moving large scale data to the application server 110.

In the disclosed embodiments, one or more user application APIs are modified to include graph based information to be offloaded into a new NFS procedural call: graph-lookup. The graph-lookup call invokes a lookup over multiple files, and a graph operation is invoked on the top of the multiple files. The graph-lookup call is an iterative procedural call that includes looking up the file name, invoking a read operation, and then applying a graph operation. A NFS graph-lookup procedural call is invoked through multiple layers of indirections, namely, a modified system call, virtual file system indirection, and then the NFS graph-lookup. A system call carries semantics information and a list of files to the NFS graph-lookup procedural call.

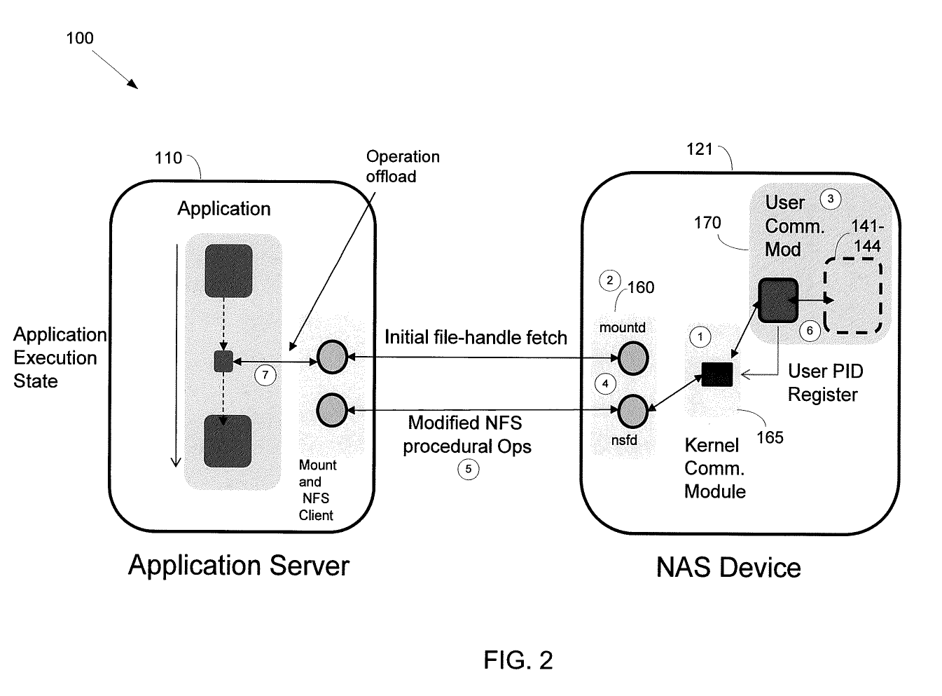

FIG. 2 illustrates an example sequence of events that occur during the offloading of graph-based operations and the deployment of process level VMs, according to this disclosure. The example sequence shown is described with respect to the system 100 of FIG. 1. The sequence is suitable for use with other systems as well.

(1) A kernel communication module 165 is loaded at the NAS device 121 as a layer of indirection to pass the modified, semantics-based graph procedural calls to the one or more process level VMs 141-144. The kernel communication module 165 acts as a container that runs the offloaded operation with one or more input and output (I/O) parameters and a system configuration file. The kernel communication module 165 creates an inter-process communication (IPC) channel between the kernel address space and the user address space, to forward the NFS call to a secured container.

(2) The modified DFS server 160 (which, for the purposes of this example, is a NFS server) is loaded into the operating system in order to establish an IPC channel user space container.

(3) A user level application module 170 is invoked to register the process ID (PID) with the kernel communication module 165 and fork at least one VM 141-144 on demand. The PID is registered in order to establish the channel of communication with the kernel communication module 165. The user level application module 170 is a user level application thread that is configured to receive a request parameter from the kernel communication module 165 to configure the sandbox environment.

(4) The modified NFS server 160 is accessed using the using nfsd and mountd protocols (rpc.mountd and rpc.nsfd programs).

(5) A client application is started, and a request for data is transformed into a modified procedural call. The modified procedural call is a virtualized NFS procedural lookup call that is embedded with graph information encoded as one or more parameters.

(6) The virtualized NFS procedural lookup is forwarded to the user level application module 170. The user level application module 170 then forks one or more VMs 141-144 for data operation offload into the secured container. This may include a hypervisor (e.g., the hypervisor 130) forking new VMs or booting pre-configured VMs.

(7) Results of the offloaded operations are sent back to the client application, instead of sending a large amount of data.

It is noted that the sequence described above is merely one example for integrating the VMs 141-144 with the application server 110. The example sequence features offloading through kernel-user indirection. The same or similar approach could be easily performed using user level indirection.

As described above, the NFS or CIFS protocol used in the system 100 is modified to support execution of graph based algorithms. The graph algorithms, which can include operations like adding or deleting an edge, are embedded into the traditional NFS or CIFS protocol with a number of graph_XXX primitives. In some embodiments, the NFS or CIFS protocol is modified by adding the following primitives to the protocol:
graph_compute(“expr”)
   Input (“expr”): a graph or data file to read data, including the algorithm type (e.g., shortest-path, depth-first search, etc.) or operation type (add, del) on the edge;
   Output: a graph in array or two-dimensional array or status
graph_compute_save(“expr”, “filename”)
   Input (“expr”)=graph or data file to read data, including algorithm type (e.g., shortest-path, depth-first search, etc.) or operation type (add, del) on the edge;
   Input (“filename”)=data filename to store the result;
   output=status
graph_from(“filename”)—can be used in conjunction with graph_compute and graph_compute_save to read information on vertices and edges from a data file
   Input=filename
   Output=Graph in array or two-dimensional array
graph_add_edge(“filename”, x, y, value)—used to add edge information on vertices
   Input (“filename”)
   Input (x, y)=source and destination vertex
   Input (value)=value associated with the edge
   Output=status
graph_del_edge(“filename”, x)—used to delete edge information on vertices
   Input (“filename”)
   Input (x)=source and destination vertex
   Output=status
graph_add_vertex(“filename”, x, value)—used to update (add) vertex information
   Input (“filename”)
   Input (x)=vertex identification
   Input (add_vertex)=value associated with the vertex
   Output=status
graph_del_vertex(“filename”, x)—used to update (delete) vertex information
   Input (“filename”)
   Input (x)=vertex identification
   Output=status

A translator or parser is used to convert the expressions (or operations) into C objects. Graphs can be partitioned into sub-graphs, and advanced parallel algorithms or operations can be executed on a sub-graph in a process level VM, which provides a sandboxing environment container. Multiple operations can be pipelined, where the output of each operation is input to the next operation.

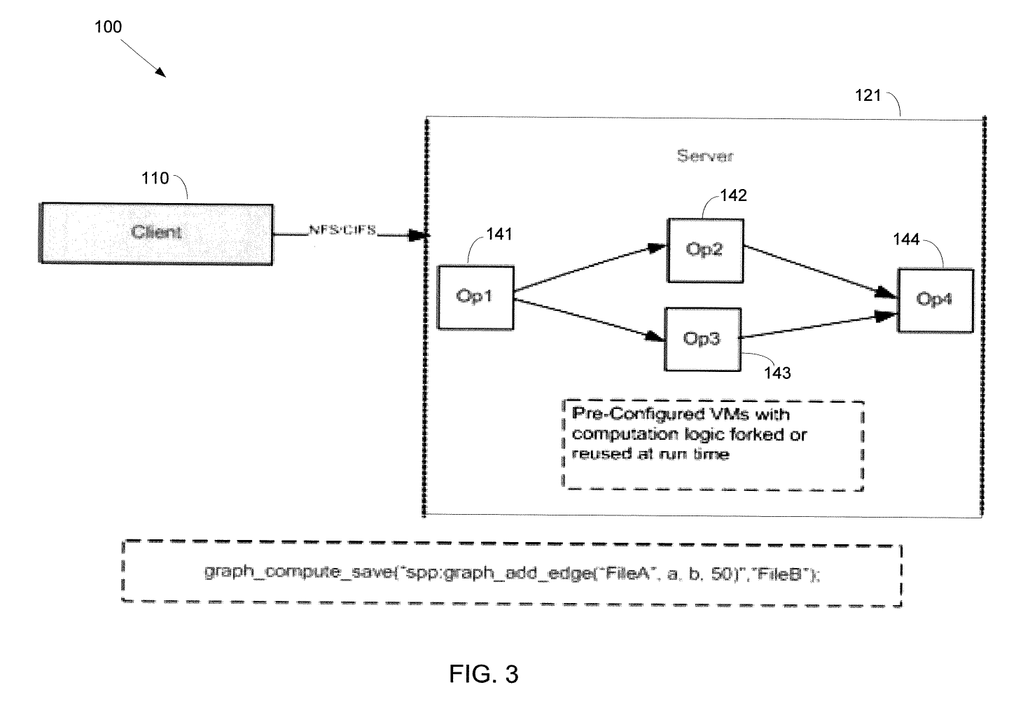

FIG. 3 illustrates an example graph computation using the graph_compute_save and graph_add_edge primitives in the system 100, according to this disclosure. The example graph computation shown is described with respect to the system 100 of FIG. 1. The graph computation is suitable for use with other systems as well. The graph computation shown in FIG. 3 is a shortest path problem (spp) example.

As shown in FIG. 3, a graph computation is invoked using the graph_compute_save( ) and graph_add_edge( ) primitives. The two primitives are pipelined together, and the resulting syntax for this example is the following:

graph_compute_save(“spp:graph_add_edge(“FileA”,a,b,50)”,“FileB”).

For graph_compute_save( ) the input parameter “expr” is “spp:graph_add_edge(“FileA”,a,b,50)” and the input parameter “filename” is “FileB”. For graph_add_edge( ) the input parameter “filename” is “FileA”, the input parameters x and y are ‘a’ and ‘b,’ respectively, and the input parameter value is 50.

The VMs 141-144 are pre-configured with computation logic, and are forked or reused at runtime. In response to the graph_add_edge( ) operation, the VM 141 reads the graph from “FileA” and adds an edge. The VMs 142-143 run parallel spp (shortest path problem) algorithms. The VM 144 then saves the result to “FileB”.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for a graph based computation, the method comprising:
receiving a procedural call from an application server, the procedural call comprising at least one primitive extended from a distributed file system (DFS) protocol;
initiating at least one virtual machine;
performing a graph based computation based on the procedural call using the at least one virtual machine; and
transmitting a result of the graph based computation to the application server.

2. The method of claim 1, wherein the at least one primitive is extended from the NFS or CIFS protocol.

3. The method of claim 1, wherein the at least one primitive comprises at least one of: graph_compute, graph_compute_save, graph_from, graph_add_edge, graph_del_edge, graph_add_vertex, or graph_del_vertex.

4. The method of claim 1, wherein the at least one virtual machine comprises a plurality of virtual machines, each virtual machine comprising a graph node associated with the graph based computation, wherein a message exchange between two of the virtual machines is associated with a graph edge associated with the graph based computation.

5. The method of claim 1, wherein the at least one virtual machine is a lightweight virtual machine initiated at a storage device.

6. The method of claim 5, wherein the storage device comprises a remote network attached storage (NAS) device configured to communicate with the application server over a network.

7. The method of claim 1, further comprising:
loading a kernel communication module to create an inter-process communication (IPC) channel between a kernel address space and a user address space and to forward the procedural call to a secured container associated with the at least one virtual machine.

8. An apparatus for a graph based computation, the apparatus comprising:
at least one memory; and
at least one processor coupled to the at least one memory, the at least one processor configured to:
receive a procedural call from an application server, the procedural call comprising at least one primitive extended from a distributed file system (DFS) protocol;
initiate at least one virtual machine;
perform a graph based computation based on the procedural call using the at least one virtual machine; and
transmit a result of the graph based computation to the application server.

9. The apparatus of claim 8, wherein the at least one primitive is extended from the NFS or CIFS protocol.

10. The apparatus of claim 8, wherein the at least one primitive comprises at least one of: graph_compute, graph_compute_save, graph_from, graph_add_edge, graph_del_edge, graph_add_vertex, or graph_del_vertex.

11. The apparatus of claim 8, wherein the at least one virtual machine comprises a plurality of virtual machines, each virtual machine comprising a graph node associated with the graph based computation, wherein a message exchange between two of the virtual machines is associated with a graph edge associated with the graph based computation.

12. The apparatus of claim 8, wherein the at least one virtual machine is a lightweight virtual machine initiated at the apparatus.

13. The apparatus of claim 12, wherein the apparatus comprises a remote network attached storage (NAS) device configured to communicate with the application server over a network.

14. The apparatus of claim 8, wherein the at least one processor is further configured to:
load a kernel communication module to create an inter-process communication (IPC) channel between a kernel address space and a user address space and to forward the procedural call to a secured container associated with the at least one virtual machine.

15. A non-transitory computer readable medium embodying a computer program, the computer program comprising computer readable program code for:
receiving a procedural call from an application server, the procedural call comprising at least one primitive extended from a distributed file system (DFS) protocol;
initiating at least one virtual machine;
performing a graph based computation based on the procedural call using the at least one virtual machine; and
transmitting a result of the graph based computation to the application server.

16. The non-transitory computer readable medium of claim 15, wherein the at least one primitive is extended from the NFS or CIFS protocol.

17. The non-transitory computer readable medium of claim 15, wherein the at least one primitive comprises at least one of: graph_compute, graph_compute_save, graph_from, graph_add_edge, graph_del_edge, graph_add_vertex, or graph_del_vertex.

18. The non-transitory computer readable medium of claim 15, wherein the at least one virtual machine comprises a plurality of virtual machines, each virtual machine comprising a graph node associated with the graph based computation, wherein a message exchange between two of the virtual machines is associated with a graph edge associated with the graph based computation.

19. The non-transitory computer readable medium of claim 15, wherein the at least one virtual machine is a lightweight virtual machine initiated at a storage device.

20. The non-transitory computer readable medium of claim 19, wherein the storage device comprises a remote network attached storage (NAS) device configured to communicate with the application server over a network.
